(19) United States
(12) Patent Application Publication
(10) Pub. No.: US 2015/0066596 A1
(43) Pub. Date: Mar. 5, 2015

(54) BEHAVIOR PRICING ANALYTICS

(71) Applicant: International Business Machines Corporation, Armonk, NY (US)

(72) Inventors: Yi-Min Chee, Yorktown Heights, NY (US); Pavankumar Murali, Haverstraw, NY (US); Anshul Sheopuri, White Plains, NY (US); Wei Sun, Tarrytown, NY (US)

(73) Assignee: International Business Machines Corporation, Armonk, NY (US)

(21) Appl. No.: 14/256,396

(22) Filed: Apr. 18, 2014

Related U.S. Application Data
(60) Provisional application No. 61/871,546, filed on Aug. 29, 2013.

(51) Int. Cl. G06Q 30/02

(52) U.S. Cl. CPC G06Q 30/0283
USPC 705/7.35

(57) ABSTRACT

A method for systematically determining a pricing strategy based on one or more of a business insight, a price perception model and a surprise model.

### CROSS REFERENCE TO RELATED APPLICATION

This application claims priority to U.S. Provisional Patent Application Ser. No. 61/871,546, filed Aug. 29, 2013, the contents of which are hereby incorporated by reference in their entirety.

### BACKGROUND

The present disclosure relates to pricing, and more particularly to creating a price strategy.

Pricing is an important component of marketing and front office operations of many businesses. Methods for selection pricing strategies are difficult to formulate.

### BRIEF SUMMARY

According to an exemplary embodiment of the present invention, a method for systematically determining a pricing strategy includes receiving, by a processor, historic transaction data for a good or service, and determining, by the processor, a probability that a customer chooses an alternative good or service given the historic transaction data and the customer's perception of a deal being offered in conjunction with the alternative good or service.

According to an exemplary embodiment of the present invention, a method for systematically determining a pricing strategy includes receiving, by a processor, historic transaction data for a plurality of goods and/or services, and determining, by the processor, an estimated profit from a sale of an alternative good and/or service given the historic transaction data and a customer's perception of a deal being offered in conjunction with the alternative good and/or service.

### BRIEF DESCRIPTION OF THE SEVERAL VIEWS OF THE DRAWINGS

Preferred embodiments of the present invention will be described below in more detail, with reference to the accompanying drawings:

FIG. 1 is a diagram of a system of modules for determining a pricing strategy according to an exemplary embodiment of the present invention;

FIG. 2 a flow diagram of a method for determining a pricing strategy according to an exemplary embodiment of the present invention;

FIG. 3 is a pricing graph according to an exemplary embodiment of the present invention; and

FIG. 4 is a diagram of a system configured to determine a pricing strategy according to an exemplary embodiment of the present invention.

### DETAILED DESCRIPTION

According to an exemplary embodiment of the present invention, behavior economics and psychology are used in creating economic performance predictions (e.g., predicted profits, revenue, sales, etc.) conditioned on factors including a customer's behavior and cognition.

According to an exemplary embodiment of the present invention, a method for creating a pricing strategy can be augmented by behavioral models. In one or more embodiments of the present invention, these behavioral models include methods for capturing a consumer's perception of discount as a factor in a purchase decision, refining a recommended pricing strategy based on the concept of surprise, subject to a risk profile of a decision-maker, and subject matter expert (SME) codification of new input (e.g., results from behavior studies). Exemplary behavioral models can be implemented in combination with one another or individually.

Referring now to general principles underlying embodiments of the present invention, the following describes exemplary concepts in econometrics, behavior economics, mathematical psychology and information theory.

In the field of econometrics, the discrete choice of models can describe a probability P that a customer n chooses alternative i (e.g., a good or service offered by a retailer) (i.e., Pni). This exemplary discrete choice model can be written as:

$$Pni = \frac{{e}^{Vni}}{{Σ}_{j = 1}^{J} {e}^{Vnj}} = \frac{{e}^{{β}_{i}^{T} Sni}}{{Σ}_{j = 1}^{J} {e}^{{β}_{j}^{T} Snj}} \qquad ( 1 )$$

Eq. 1 specifies the probability P that a person n chooses a particular alternative i from a choice set, where Vₙⱼ represents the deterministic part of person n's utility from choosing alternative j. The deterministic part of the utility, Vₙⱼ, can be specified to be linear in parameters, i.e., Vₙⱼ=βⱼ^{T}Sₙⱼ, where Sₙⱼis a vector of observed attributes relating to alternative j, βⱼ is a vector of coefficients, which is alternative-specific, and T is time. The choice of an alternative depends on the attributes of the customer and the alternative. The attributes of the customer can include income level, age, location, acquisition, click-through rate, etc. The attributes of the alternative can include price, size, color, review ratings, discount, etc. It should be understood that the attributes described herein are exemplary and that the scope of the present invention is not limited to the exemplary attributes. Indeed, various alternative or additional attributes can be used.

In the field of behavior economics, the power of “free” can be exemplified by a choice between two goods of the same type and of different price and different quality. For example, in a case of two chocolates of different quality, in a first scenario (scenario 1), the two different chocolates are offered to customers at 1 cent and 15 cents, respectively for the lower quality chocolate and the higher quality chocolate. In a second scenario (scenario 2), the two different chocolates are offered to customers at 0 cents (i.e., free) and 14 cents, respectively for the lower quality chocolate and the higher quality chocolate. Behavior economics predicts that the customer preferences will be reversed in scenario 2 versus scenario 1, because price reduction becomes non-linear when the price reaches “free.” That is, a typical customer will prefer the lower quality chocolate when it is free.

One or more embodiments of the present invention optimize the discount strategy to increase (e.g., maximize) the retailer's objective (e.g., profit, revenue, sales, etc.). The behavior pricing can be used to predict whether an aggregate profitability will increase with a certain discount, e.g., an expected profit of $220 with no discount versus an expected profit of $290 with an 8% discount. Likewise, the behavior pricing can be used to predict whether a high discount will be detrimental to the aggregate profitability.

Turning now to the mathematical psychology of the thrill of the deal as described in Weber-Fechner's law, in one or more embodiments of the present invention, the perception p of a deal can be determining. Consider that Weber-Fechner's law can be written as:

$$p = k ln \frac{S}{{S}_{0}} , \qquad ( 2 )$$

where S is the stimulus, S₀ is a threshold below which there is no perception, and k is a parameter to be estimated.

In view of the foregoing, the thrill of the deal can be included in a model to predict outcomes (e.g., the probability of a purchase versus the discount % or the predicted profit versus the discount %), both with a behavior pricing model and without a behavior pricing model. In one or more embodiments, the behavior pricing model is applied to increase (e.g., maximize) an attribute such as sales, revenue or profit. In one or more embodiments, the model is constrained by one or more of a time period (e.g., a period during which to offer a discount), a budget value, a maximum discount amount or percentage, whether to offer the discount on multiple orders, etc. Furthermore, in one or more embodiments, the model is constructed from a certain population, such as high or low earners.

It should be understood that the present disclosure is not limited to either the attributes or constraints described herein, and that additional attributes or constraints are possible, for example, a constraint specifying that a promotion can be used on multiple orders.

In the context of information theory, a Bayesian surprise S can be written as:

$$S ( D , M ) = LKL ( P ( M \vert D ) , P ( M ) ) = {\int }_{M} P ( M \vert D ) log \frac{P ( M \vert D )}{P ( M )} d M \qquad ( 3 )$$

where D is a new data observation, M is a hypotheses or model, M is the model class or space, LKL is a Kullback-Leibler (KL) divergence, P(M) is a prior distribution, and P (M|D) is a posterior distribution.

The Bayesian surprise quantifies how stimulus affects natural or artificial observers, by measuring differences between posterior beliefs and prior beliefs of the observers. Stated another way, Eq. 3 is useful in evaluating how surprising the model recommendations are compared to customer prior beliefs.

Exemplary recommendations may specify a certain discount correlating to a certain value of expected profit. The price perception model may predict that as demand changes are more gradual after a certain discount, say 15%, the low discount level is sufficient to capture “the thrill of deal” and maintain profitability. The measure of maintaining profitability can vary by the type of product, the business model of the service provider, etc.

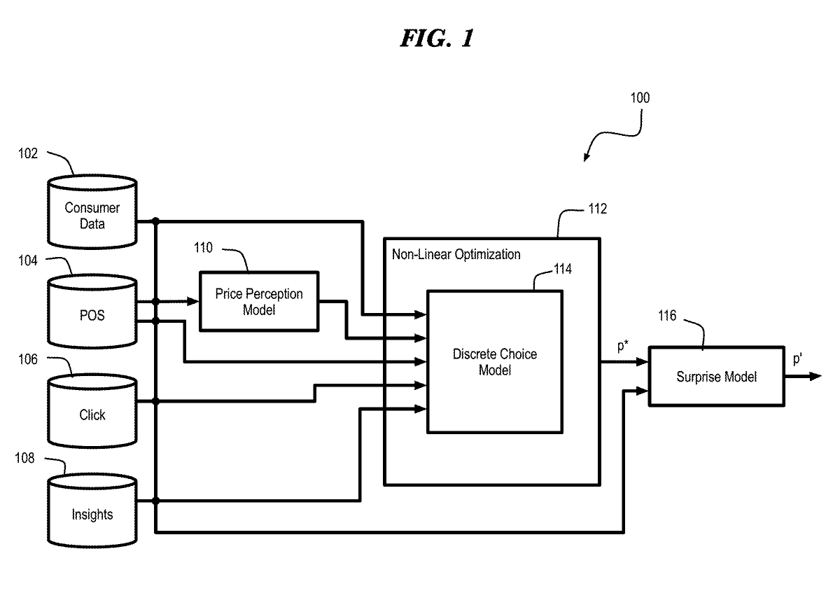

Referring now to FIG. 1, an exemplary system 100 for modeling a retailer's business model. In one or more embodiments of the present invention, a method systematically determines a discount based on the customer's perception of a promotion. That is, in one or more embodiments, a decision-making method is used in determining a pricing strategy, including a price and a marked discount on a product or service. Further, in one or more embodiments, a recommendation is evaluated and refined to suit a risk profile of the business (e.g., store or service provider).

In one or more embodiments, a non-linear optimization module 112 takes input data from sources including a customer data module 102, a point of sale module 104, a web traffic module 106 and an insight module 108. The non-linear optimization module 112 outputs a perception, p*. The non-linear optimization module 112 can further use business constraints, user-specified objectives, and targeted product, customer groups in determining p*.

In one or more embodiments, the insight module 108 provides information about how customers react to certain offers (e.g., an offer of a free service), which measures an emotional charge perceived about what is being offered (e.g., is a service perceived as being more valuable or less valuable), inducing sharp changes in preferences. That is, the insight module 108 reveals business insights from behavior experiments. In one or more embodiments, the data of the insight module 108 (e.g., new input) is coded by SMEs to incorporate behavior aspects into the modeling.

Further, in one or more embodiments, information from the point of sale module 104 is applied to the non-linear optimization module 112 through a price perception model module 110, which models a customer's perception of a discount for the retailer. In one or more embodiments, the price perception model module 110 employs Weber-Fechner's law from mathematical psychology to model the perception of a discount that is used to estimate purchase probabilities. Here, the choice probabilities that are the output of module 114 can be different without including behavior factor.

In one or more embodiments, the concept of surprise is used to estimate the risk of a decision, for example, offering 0% discount (eliminating sales) may be too risky for a given store whose customers have been used to promotions. In FIG. 1, the non-linear optimization module 112 includes a discrete choice model module 114, which acts on the input to determine the perception, p*. The perception, p*, is applied to a surprise model module 116, which processes the p* to determine a refined perception, p′, based on how surprising the new strategy is, subject to a risk profile (e.g., specifying a target level of the risk of the decision) and preference (e.g., a maximum discount percentage, whether to allow a promotion to be used on multiple orders) of the retailer.

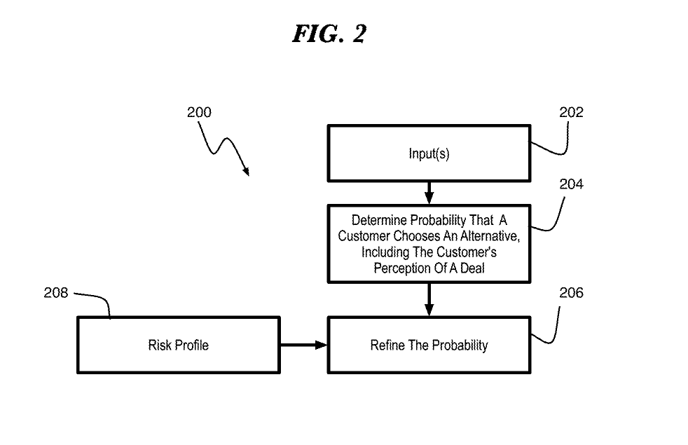

Referring to FIG. 2, an exemplary method 200 for determining a pricing strategy includes determining a probability that a customer chooses an alternative 204 given certain historic transaction data as input 202. In one or more embodiments, the input includes business insights coded by SMEs and/or a price perception of the customer. The probability that a customer chooses an alternative includes the customer's perception of the deal being offered. The probabilities are input into the nonlinear optimization model, which processes (e.g., maximizes) the objective (e.g., expected profit, revenue, sales etc.) subject to business constraints. The output is a pricing or discount strategy.

At block 206, the strategy is refined given a risk profile 208 of the retailer making the offer.

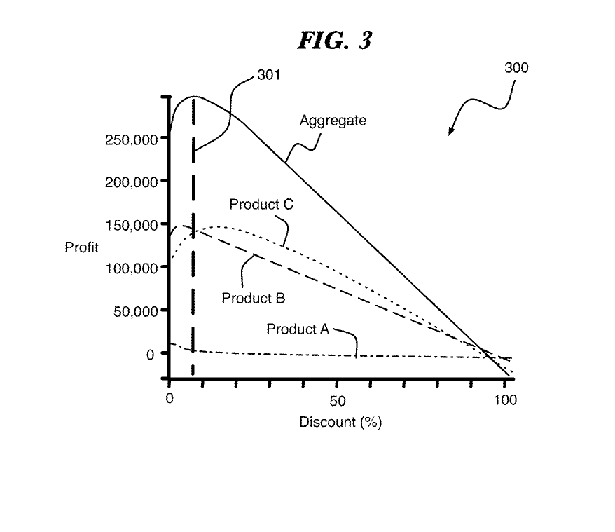

FIG. 3 is a pricing graph 300 according to an exemplary embodiment of the present invention. FIG. 3 shows profit versus discount, measured as a percentage, for three products (products A, B and C) and an aggregate of a plurality of goods and/or services (e.g., in the case of a store-wide sale). Given the relationship of profit and discount for each product a strategy can be formulated for a certain objective or business goal (e.g., the profitability from FIG. 2). In the example of the aggregate, it can be seen that a maximum profit corresponds to a discount of about 8%, indicated by line 301. In one or more exemplary embodiments, the profit is determined using a behavior pricing model capturing a consumer's perception.

It should be understood that the methodologies of embodiments of the invention may be particularly well-suited for predicting an impact of a service level agreement.

By way of recapitulation, according to an exemplary embodiment of the present invention, a method for predicting an impact of a service level agreement includes collecting workload data and effort data and constructing a cost model for the service level agreement, defining a baseline staffing of the service level agreement, and calibrating the cost model of the service level agreement, by calibrating a workload volume from the workload data and an effort time from the effort data to match the baseline staffing, to output a service level agreement impact model.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor”, “circuit,” “module” or “system.”

Furthermore, it should be noted that any of the methods described herein can include an additional step of providing a system for systematically determining a pricing strategy (see for example, FIG. 1) comprising distinct software modules embodied on one or more tangible computer readable storage media. All the modules (or any subset thereof) can be on the same medium, or each can be on a different medium, for example. The modules can include any or all of the components shown in the figures. In a non-limiting example, the modules include the non-linear optimization module 112, including the discrete choice model module 114, which acts on the input, including the customer's perception of a discount from the price perception model module 110 and data from the insight module 108, to determine the perception, p*. The perception, p*, is applied to a surprise model module 116, which processes the p* to determine a refined perception, p′, based on how surprising the new strategy is, subject to a risk profile of the retailer. Further, a computer program product can include a tangible computer-readable recordable storage medium with code adapted to be executed to carry out one or more method steps described herein, including the provision of the system with the distinct software modules.

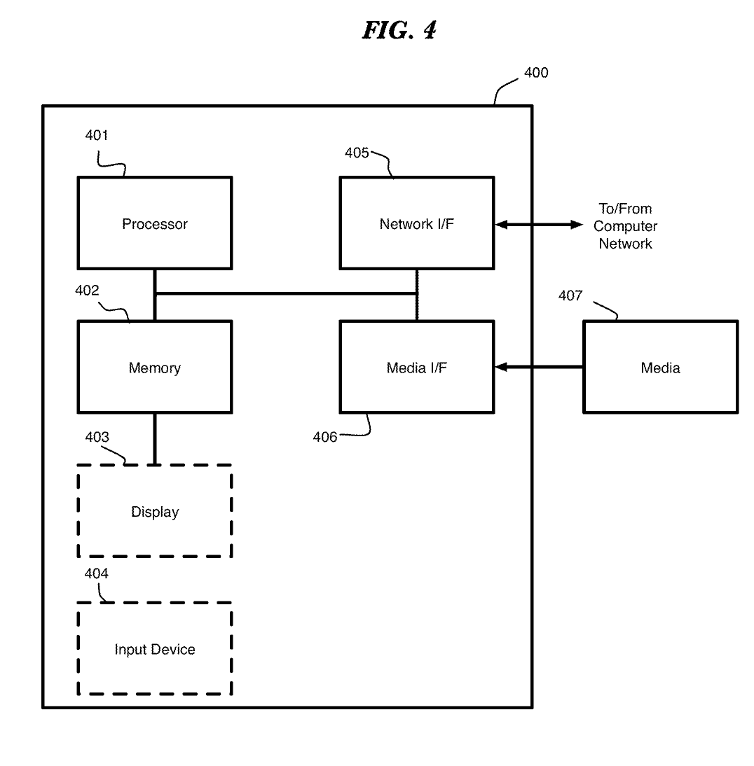

Referring to FIG. 4; FIG. 4 is a block diagram depicting an exemplary computer system for systematically determining a pricing strategy according to an embodiment of the present invention. The computer system shown in FIG. 4 includes a processor 401, memory 402, display 403, input device 404 (e.g., keyboard), a network interface (I/F) 405, a media IF 406, and media 407, such as a signal source, e.g., camera, Hard Drive (HD), external memory device, etc.

In different applications, some of the components shown in FIG. 4 can be omitted. The whole system shown in FIG. 4 is controlled by computer readable instructions, which are generally stored in the media 407. The software can be downloaded from a network (not shown in the figures), stored in the media 407. Alternatively, a software downloaded from a network can be loaded into the memory 402 and executed by the processor 401 so as to complete the function determined by the software.

The processor 401 may be configured to perform one or more methodologies described in the present disclosure, illustrative embodiments of which are shown in the above figures and described herein. Embodiments of the present invention can be implemented as a routine that is stored in memory 402 and executed by the processor 401 to process the signal from the media 407. As such, the computer system is a general-purpose computer system that becomes a specific purpose computer system when executing routines of the present disclosure.

Although the computer system described in FIG. 4 can support methods according to the present disclosure, this system is only one example of a computer system. Those skilled of the art should understand that other computer system designs can be used to implement embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method for systematically determining a pricing strategy comprising the steps of:
receiving, by a processor, historic transaction data for a good or service; and
determining, by the processor, a probability that a customer chooses an alternative good or service given the historic transaction data and the customer's perception of a deal being offered in conjunction with the alternative good or service.

2. The method of claim 1, further comprising including a price perception of prior sales in the historic transaction data.

3. The method of claim 1, further comprising including a business insight in the historic transaction data.

4. The method of claim 1, further comprising refining, by the processor, the probability given a risk profile of a retailer offering the deal.

5. The method of claim 4, wherein refining the probability includes predicting a measure of surprise of the customer given the offered deal.

6. The method of claim 4, further comprising providing a system, wherein the system comprises distinct software modules, each of the distinct software modules being embodied in a non-transitory computer program product embodied in a computer readable medium, and wherein the distinct software modules comprise a price perception module, a non-linear optimization module, and a surprise module;
wherein:
said step of receiving the historic transaction data is carried out by the price perception module and the non-linear optimization module simultaneously, the price perception module and the non-linear optimization module executing on the processor;
said step of determining the probability that the customer chooses the alternative good or service is carried out by the non-linear optimization module executing on the processor and receiving an output of the price perception module; and
said step of refining the probability given the risk profile of the retailer offering the deal is carried out by the surprise module executing on the processor.

7. A computer program product for systematically determining a pricing strategy, the computer program product comprising a computer readable storage medium having program instructions embodied therewith, the program instructions executable by a processor to cause the processor to perform a method comprising:
receiving historic transaction data for a good or service; and
determining a probability that a customer chooses an alternative good or service given the historic transaction data and the customer's perception of a deal being offered in conjunction with the alternative good or service.

8. The computer program product of claim 7, further comprising including a price perception of prior sales in the historic transaction data.

9. The computer program product of claim 7, further comprising including a business insight in the historic transaction data.

10. The computer program product of claim 7, further comprising refining the probability given a risk profile of a retailer offering the deal.

11. The computer program product of claim 10, wherein refining the probability includes predicting a measure of surprise of the customer given the offered deal.

12. A method for systematically determining a pricing strategy comprising the steps of:
receiving, by a processor, historic transaction data for a plurality of goods and/or services; and
determining, by the processor, an estimated profit from a sale of an alternative good and/or service given the historic transaction data and a customer's perception of a deal being offered in conjunction with the alternative good and/or service.

13. The method of claim 12, further comprising including a price perception of prior sales in the historic transaction data.

14. The method of claim 12, further comprising including a business insight in the historic transaction data.

15. The method of claim 12, further comprising refining, by the processor, the estimated profit given a risk profile of a retailer offering the deal.

16. The method of claim 15, wherein refining the estimated profit includes predicting a measure of surprise of the customer given the offered deal.

17. The method of claim 15, further comprising providing a system, wherein the system comprises distinct software modules, each of the distinct software modules being embodied in a non-transitory computer program product embodied in a computer readable medium, and wherein the distinct software modules comprise a price perception module, a non-linear optimization module, and a surprise module;
wherein:
said step of receiving the historic transaction data is carried out by the price perception module and the non-linear optimization module simultaneously, the price perception module and the non-linear optimization module executing on the processor;
said step of determining the estimated profit is carried out by the non-linear optimization module executing on the processor and receiving an output of the price perception module; and
said step of refining the probability given the risk profile of the retailer offering the deal is carried out by the surprise module executing on the processor.

18. A computer program product for systematically determining a pricing strategy, the computer program product comprising a computer readable storage medium having program instructions embodied therewith, the program instructions executable by a processor to cause the processor to perform a method comprising:
receiving historic transaction data for a plurality of goods and/or services; and
determining an estimated profit from a sale of an alternative good and/or service given the historic transaction data and a customer's perception of a deal being offered in conjunction with the alternative good and/or service.

19. The computer program product of claim 18, further comprising refining the estimated profit given a risk profile of a retailer offering the deal.

20. The computer program product of claim 19, wherein refining the estimated profit includes predicting a measure of surprise of the customer given the offered deal.
